(19) United States
(12) Patent Application Publication
(10) Pub. No.: US 2001/0026756 A1
(43) Pub. Date: Oct. 4, 2001

(54) Lift for a motorized vehicle or the like

(76) Inventor: Dennis L. Mortimore, Medford, OR (US)

Correspondence Address: Gregory J. Nelson, NELSON & ROEDIGER, Suite 212, 3333 E. Camelback Road, Phoenix, AZ, 85018, US

(21) Appl. No.: 09/770,574

(22) Filed: Jan. 26, 2001

Related U.S. Application Data
(60) Provisional application No. 60/178,764, filed on Jan. 28, 2000.

(51) Int. Cl. B65G 67/02

(52) U.S. Cl. 414/556; 414/917; 414/462; 414/921

(57) ABSTRACT

A lift carried in a van or a similar transporting vehicle to load and unload cargo such as a mobility scooter. A base reciprocable on a track. The base carries an extendable and retractable lift arm assembly which includes a pair of parallel linkages. The lift arm assembly carries an elevator platform to accommodate the load. An actuator moves the base lift arm assembly and platform from a stored position in the vehicle to a loading and unloading position adjacent a rear or side door.

This Application is based on Provisional Application Ser. No. 60/178,764, filed Jan. 28, 2000, titled: “Lift For A Motorized Vehicle Or The Like.”

### FIELD OF THE INVENTION

The present invention relates to a lift and more particularly to a motorized lift for raising and lowering items such as small vehicles of the type used by disabled persons into and out of a transporting vehicle such as a van or utility vehicle.

Many disabled individuals rely on small, personal, motorized vehicles for mobility. These vehicles are often termed “mobility carts or scooters” and are available from a number of manufacturers such as Amigo, Rascal and others. Generally these vehicles are small electric powered scooters which are transported in a car, van or truck and unloaded when they are to be used at a mall, supermarket or other location. Small mobility vehicles of this type generally weigh one to two hundred pounds and therefore is necessary that some type of lifting device or ramp be utilized for loading or unloading the cart from the transporting vehicle. Accordingly, individuals utilizing carts of this type will often transport the cart in a vehicle or van which vehicle or van is specially modified having a ramp or lift so that the motorized cart may driven into and out of the van or vehicle.

An alternative to specially modified vehicles having ramps or elevators is the use of a hoist device which enables the cart to be lifted in and out of the transporting vehicle. Many such lifting devices can be found and generally are utilized with specialized vans and may require extensive installation and modification of the van.

Hoist devices mounted to the trunk of automobiles or in the rear of vehicles such as utility vehicles are also available. Reference is made to U.S. Pat. Nos. 3,804,263; 4,217,200; 4,391,379 and 5,431, 526 which patents are representative of motorized lifting devices utilized with the transporting vehicle. These hoists often require special attachments to connect them to the scooter or cart.

Another approach to the problem of conveniently transporting motorized carts is the use of an exterior platform which is mounted on the rear bumper of the transporting vehicle which platform includes an elevator lift mechanism. The disadvantage of this type of device is that the platform increases the overall length of the transporting vehicle and the exterior mounting exposes the loaded scooter to weather conditions. Vandalism and theft may also be a problem since the scooter is exposed. The rear bumper mounting may also interfere with the normal access to the trunk of the vehicle.

Accordingly, there exists a need for an effective, convenient and reliable device for lifting a mobility cart or scooter into and out of a transporting vehicle.

### SUMMARY OF THE INVENTION

Briefly, the present invention provides a lift device which is operable to raise a scooter, cart or other object to the floor level of a van or other transporting vehicle and thereafter retract the scooter to a stored position within the van. When the scooter is to be unloaded, the rear doors or gates of the van or vehicle are opened and a mounting plate will move outwardly to a position so that the scooter is positioned above the surface at the rear of the van. The lift is then operated to lower the scooter to the surface level so that the scooter can be driven or rolled off the lift platform. The lift is attached to the floor of the van with minimum modifications being required.

The lift of the present invention has a base which is attachable to the floor of the van by fasteners such as bolts. The base defines a pair of spaced-apart tracks. A mounting plate is reciprocal on rollers within the tracks in the cargo area of the vehicle. A first motor operates an actuator, such as a lead screw, to cause the plate to reciprocate along the tracks between a forward (stored) and a rear (loading or unloading) position. Appropriate controls limit the forward and rear reciprocation of the base.

The mounting plate carries a lift arm assembly which includes a pair of parallel linkages, the lower ends of which are attached to a bottom plate which is secured to the reciprocal mounting plate. The opposite end of the parallel linkages are secured to a top retainer. An actuator, such as a hydraulic actuator or lead screw, can be extended and retracted to operate the linkages. In the retracted position, the lift arm assembly assumes a generally vertical position with the linkages collapsed. In the extended position, the linkages move from the vertical position to a generally horizontal position. The top retainer is attached to a support bar which carries a platform. The platform has a pair of spaced-apart, parallel tracks positioned to accommodate and align with the cart wheels. Preferably the tracks include a wheel well or recess so that the vehicle is stabilized once it is driven onto the tracks on the platform.

To operate the lift, the operator will energize the first motor which will cause the lead screw to move the mounting plate rearwardly to a loading or unloading position near the rear of the vehicle. Appropriate micro switches are positioned along the tracks to limit the forward and rear movement of the mounting plate. Once the plate assumes the rearward loading and unloading position, the second motor is energized causing the parallel linkage lift arm assembly to pivot rearwardly from a vertical position to a generally horizontal position. In the generally horizontal position, the elevator or platform is positioned on the surface to allow the mobility scooter to be either loaded or unloaded. Once the loading or unloading operation has taken place, the lift arm assembly is actuated to retract it moving it to a vertical position thereby raising the elevator platform. The first motor is then energized causing the lift arm assembly to move to a forward position within the vehicle so the rear doors of the vehicle may be closed.

### BRIEF DESCRIPTION OF THE DRAWINGS

The above and other objects and advantages of the present invention will be more fully understood from the following description and drawings in which:

FIG. 1 is a perspective view of the lift or the present invention shown in a loading or unloading position;

FIG. 2 is a side view showing the lift in a partially raised or lowered position;

FIG. 3 is a perspective view of the lift of the present invention shown in the retracted or stored position;

FIG. 4 is a perspective view of the mounting frame shown installed in the rear of a vehicle;

FIG. 5 shows a mobility cart loaded onto the elevator platform at the rear of a vehicle;

FIG. 6 is a partial detail view of the track and base plate assembly; and

FIG. 7 is a front detail view of the lift arm connection to the upper plate of the linkage assembly.

### DETAILED DESCRIPTION OF THE DRAWINGS

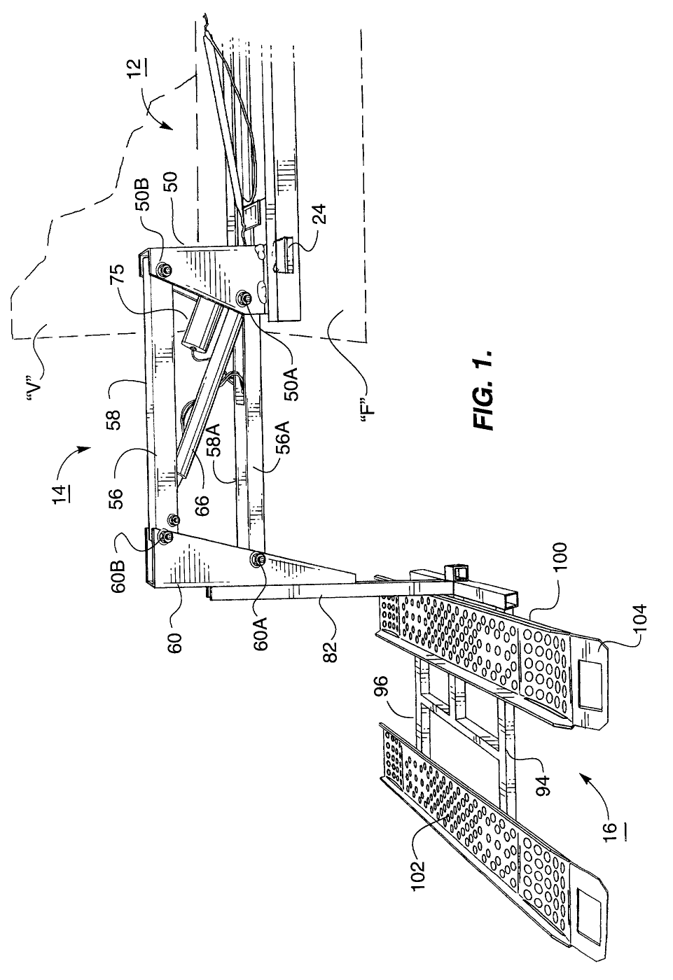

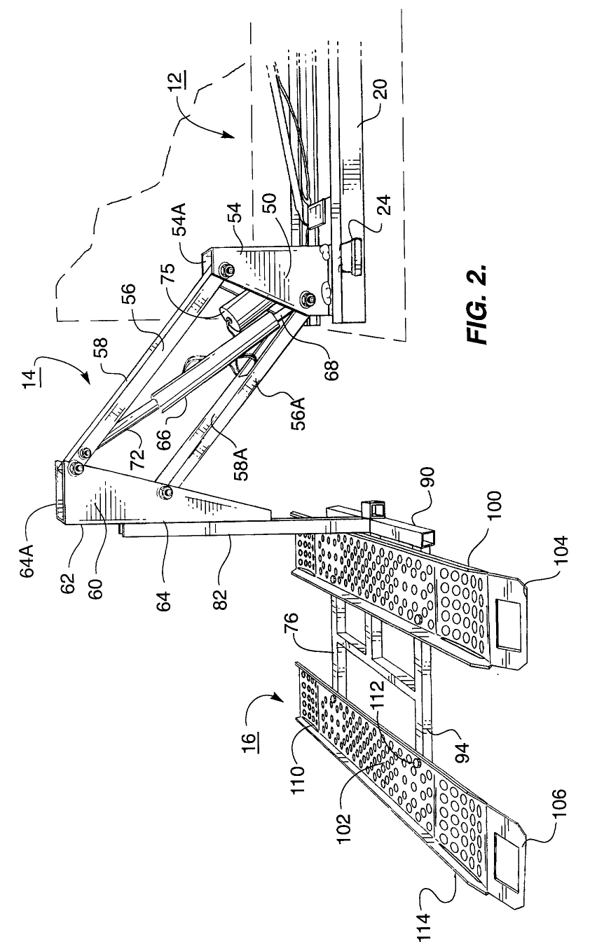

Referring now to the drawings, the lift of the present invention is generally designated by the numeral 10 and includes a base assembly 12, lift arm assembly 14 and an elevator platform assembly 16. The base assembly 12 includes a track frame 19 having a pair of parallel channels or tracks 18 and 20 which are spaced-apart. The channels each are U-shaped and each define an inwardly facing track surface 21. For the purpose of illustration, drawing FIGS. 1 to 5 represent an installation in a van or similar vehicle “V” with dotted lines representing the floor and sidewalls of the vehicle.

Mounting tabs 24 are welded or otherwise secured to the outer surface of the channels to provide location for securement of the track frame 19 to the interior of a vehicle preferably by placing bolts through the mounting tabs and the floor and/or frame of the vehicle. A first motor 22 is mounted at the inner or forward end of the track assembly and operates a drive seen as an axially extending lead screw 26 which may be reversely operated by the motor. Although a lead screw is shown, other mechanical equivalents may be used such as direct gear drives, sprocket and chain drives, hydraulic or pneumatic actuators to achieve reciprocal motion of the plate 30.

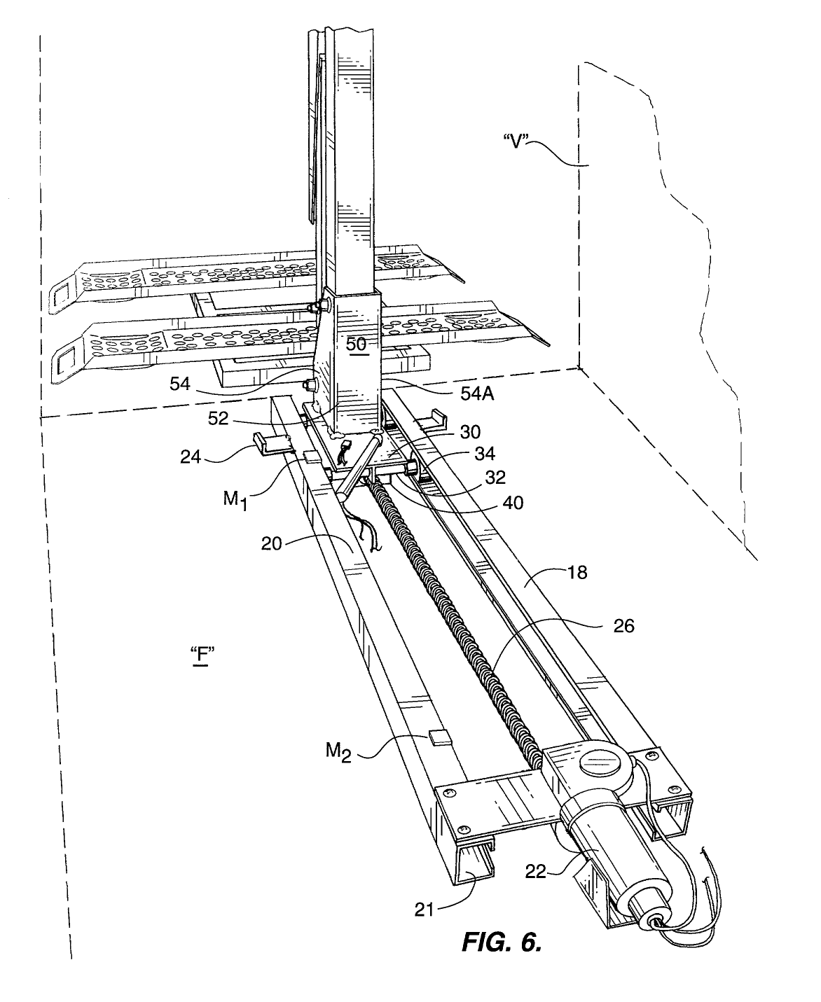

As seen in FIG. 6, mounting plate 30 is reciprocal along the tracks 18 and 20 and operates as a “truck” for the lift and platform assemblies 14, 16. The plate 30 has axles 32 each of which carry a suitable roller 34 such as a roller of low-friction material. A follower 40 is secured to the plate 30 and receives the lead screw. The rollers 32 are positioned on the track surfaces 21 so that the mounting plate 30 may easily reciprocate back and forth along the tracks. Suitable micro switches M1, M2 are placed along the tracks at selected spaced-apart locations to limit the forward and rearward movement of the reciprocating mounting plate.

It will be apparent that by rotating the lead screw 26 in one direction of rotation, the plate 30 will move rearwardly and reversely, operating the motor 22 in the other direction, will cause the plate 30 to reciprocate a forward direction.

The plate 30 supports a lower mounting plate assembly 50 which is welded to plate 30. The lower mounting plate 50 assembly is shown as being generally U-shaped having a vertical end wall 52 and generally triangular shaped side walls 54 and 54A. A first pair of parallel linkage arms 56 and 56A are pivotally secured to the lower mounting plate assembly 50 at side wall 54. A second pair of parallel linkage arms 58 and 58A are pivotally secured to the opposite side wall 54A. The upper or outer ends of the linkage arms are pivotally secured to an upper mounting plate 60 which again is generally U-shaped having an end wall 62 and opposite generally triangular side walls 64 and 64A. Arms 56A and 58A, which may be a unitary U-shaped structure, are pivotally attached to the opposite mounting plates at 60A and 50a. Similarly arms 56 and 58, which may also be a unitary U-shape, are pivotally attached to the mounting plates at pivot points 60B and 50B establishing a parallel linkage mechanism.

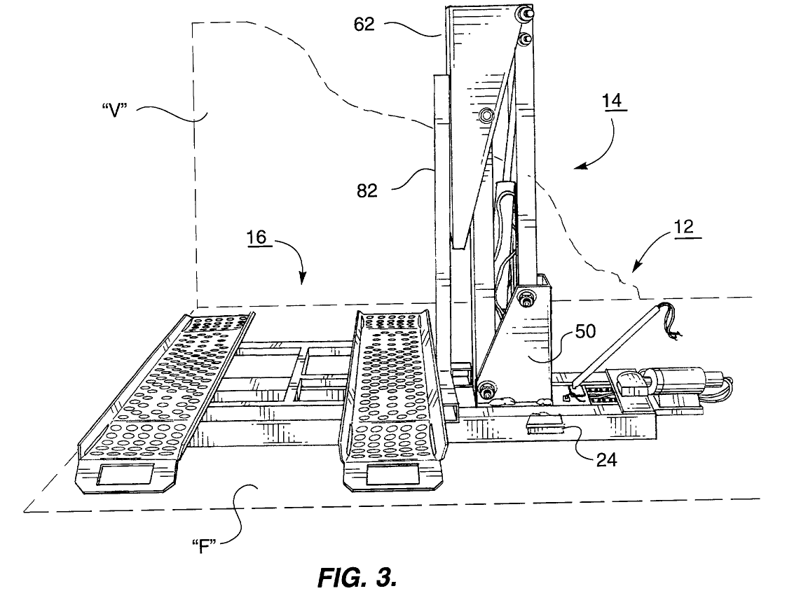

An actuator 66 has a head end 68 pivotally secured to the lower mounting plate at its lower end at pivot point 70. The end of extendable rod 72 of the actuator is pivotally attached at point common with the pivot points of linkages 56, 56A at plate 60. The actuator may be a hydraulic, pneumatic or an electrically operated actuator having a motor 75 which has a gear drive which upon energization will cause the rod 72 to extend or retract. Since the linkage assembly is a parallel linkage arrangement, extension of the actuator rod 72 will cause the linkage assembly to pivot to the generally horizontally loading and unloading position shown in FIG. 1. Retraction of the rod actuator 72 will cause the parallel linkage assembly to pivot upwardly to the generally vertical, stored position shown in FIG. 3 and extension will pivot the lift to the position of FIG. 1. Motor controls are provided and are well-known to those skilled in the art, and, in the interest of focusing on the description on the lift invention details, detailed description of the motor controls believed unnecessary. Suffice it to say, the motor controls are preferably contained in a separate hand-held remote controller 78 which controls the operation of both the motors 22 and 75. Micro switches M1, M2 are positioned to stop the lift at the loading and unloading position and the vertical stored position.

As seen in FIG. 7, the upper mounting 60 plate carries a lift arm 82 which may be welded to the end wall 62 or may be secured by bolts 85 so that the position of the platform assembly 16 at the lower end of the arm 82 relative to the vehicle floor “F” can be adjusted to accommodate installation in vehicles of different heights. Thus the end wall 62 carries bolt 85 which can be received in registry with one of a selected number of holes 84 in the upper end of the arm 82 to adjust the vertical position of the platform relative to the base assembly 12.

The platform at the lower end of the arm 82 consists of a welded frame having opposite sides 90 and transverse frame members 94 and 96. Side member 90 is welded to the lower end of the lift arm 92. The frame carries a pair of parallel disposed tracks 100 and 102. The tracks have inclined ramp members 104 and 106 at one end and are each provided with a well or depression 110 near or adjacent to the opposite end. The tracks are secured to the frame by bolts 112 so that the relative spacing of the ramps to the frame may be adjusted in accordance with the physical dimensions of the mobility cart with which the assembly is to be used. The tracks are shown as having longitudinally extending side rails 114 to guide the wheels of the mobility cart. Further, the tracks have been relieved of material to reduce the weight of the lift assembly.

### Operation

The lift may be used in any suitable environment for lifting wheeled objects but has particular application in connection with mobility scooters and accordingly is described installed with a vehicle such as a van or utility vehicle “V.” The lift is installed by securing the mounting tabs 24 to the floor of the vehicle by bolts so that the rear of channels 18 and 20 are slightly inward of the interior of the rear vehicle doors.

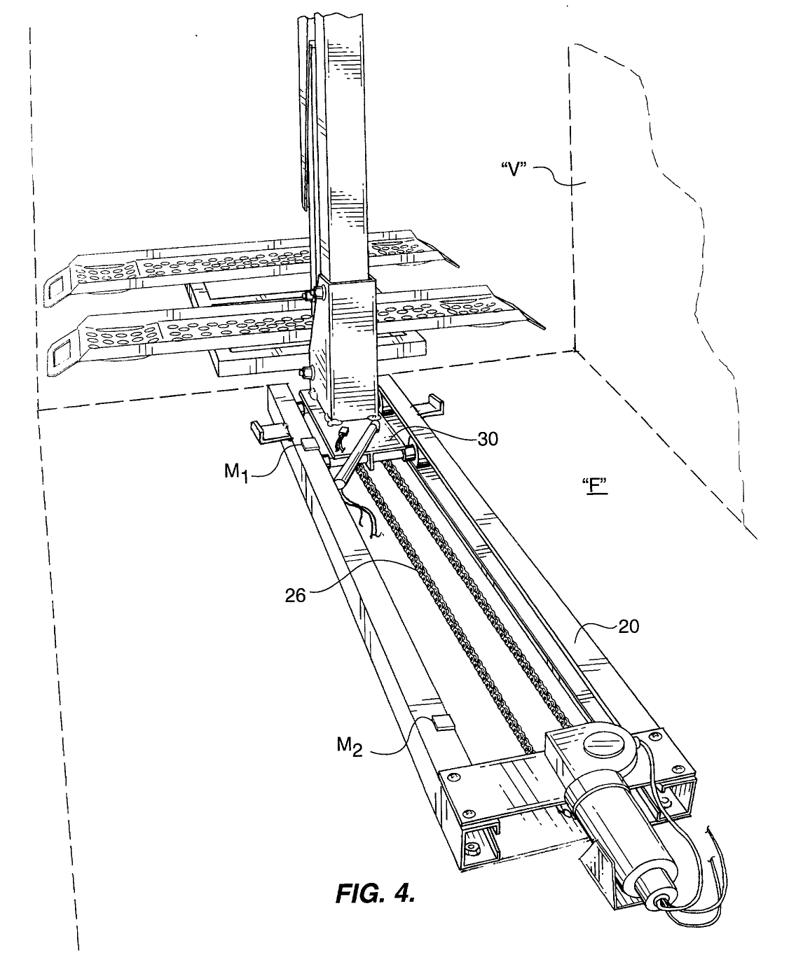

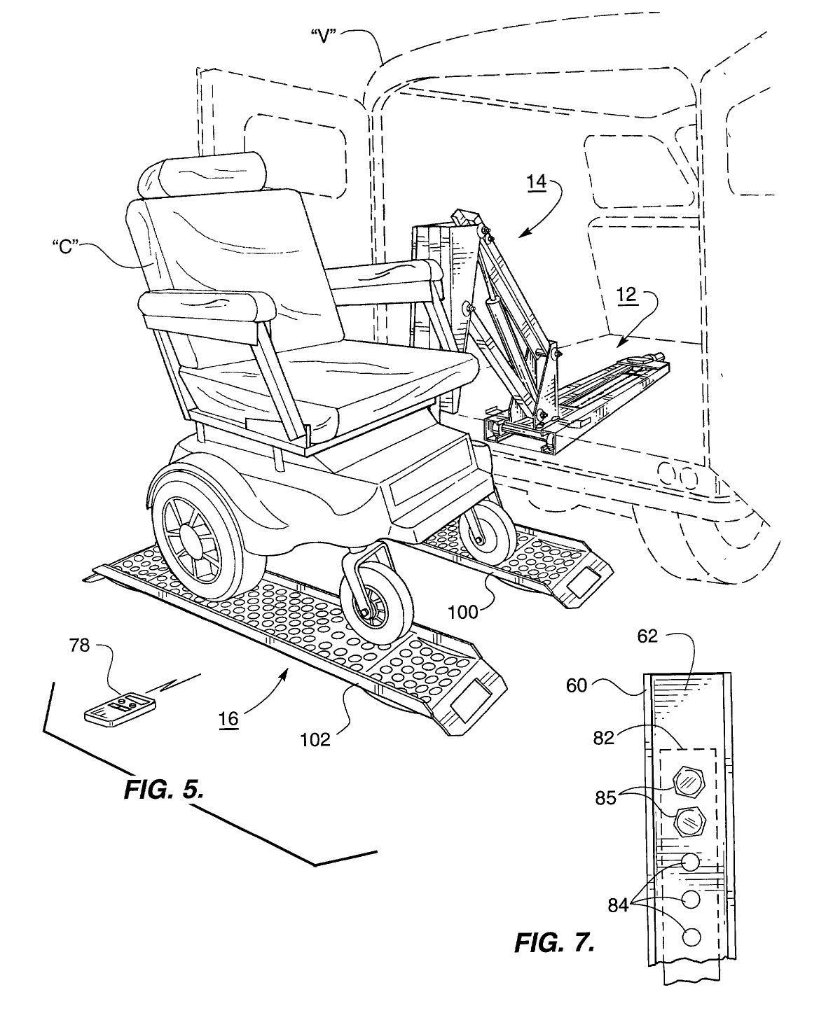

In operation, the operator using the remote control 78 will energize motor 22 causing the base plate assembly 12 to be moved rearwardly by the lead screw 26 to a position near the rear of the vehicle, as seen in FIG. 4. The vehicle rear door or gate is opened. The linkage arms are in the vertical position. Once the lift arm assembly has moved to the rearward position, the operator will energize actuator 66 causing the actuator rod 72 to extend. The extension of the rod will pivot the lift arm assembly causing it to move to the position of a generally horizontal position as seen in FIGS. 1 and 5. As the linkage pivots to a horizontal position, the attached platform 16 is moved from the elevated position to a lowered position on the surface at the rear and exteriorly of the vehicle. Once the platform is lowered, a stop is engaged and the device is de-energized, a mobility cart “C” can then be driven onto or off the tracks. FIG. 5 shows the platform in an intermediate position as cart on the platform is being raised or lowered. Once the loading or unloading procedure has been completed, the operator will then reversely operate the lift arm motor causing the linkage assembly to pivot to the upward position. As the rod 72 retracts, the platform will be moved upwardly and also inwardly to a position generally as shown in FIG. 3. Once this has been accomplished, motor 75 is de-energized and motor 21 is energized causing the lead screw 26 to operate in a direction to move the base plate and the attached linkage arm and platform forwardly to a stored position within the cargo area of the van.

While the principles of the invention have been made clear and the illustrative embodiments set forth above, it will be obvious to those skilled in the art to make various modifications to the structure, arrangement, proportion, elements, materials and components used in the practice of the invention. To the extent that these various modifications do not depart from the spirit and scope of the appended claims they are intended to be encompassed therein.

I claim:

1. A cargo lift comprising:
(a) a base frame having a track;
(b) a mounting plate reciprocal along said track;
(c) drive means for reciprocating said mounting plate between first and second positions along said track;
(d) a parallel linkage assembly carried on said mounting plate;
(e) actuator means for pivoting said linkage assembly between a generally vertical and a generally horizontal position; and
(f) a platform attached to said linkage assembly whereby said platform may be moved between a loading and unloading position on a surface to a stored position in which said platform is raised and reciprocated to a retracted position.

2. The lift of claim 1 wherein said first drive means comprises a lead screw reciprocal within a follower on said mounting plate.

3. The lift of claim 1 wherein said drive means and said actuator means each have an electric motor and are remotely controlled.

4. The lift of claim 1 wherein said lift for a wheeled mobility cart and wherein said platform comprises spaced-apart ramps.

5. The lift of claim 1 wherein said platform is adjustably attached to said linkage assembly.

6. The lift of claim 1 wherein said parallel linkage assembly comprises first and second arm assemblies.
